(19) United States
(12) Patent Application Publication
(10) Pub. No.: US 2025/0102622 A1
(43) Pub. Date: Mar. 27, 2025

(54) CONCEPT OF MEASURING BASEBAND GROUP DELAY AND LOCAL OSCILLATOR PHASE TRANSFER FUNCTION FOR RADAR APPLICATIONS

(71) Applicant: Infineon Technologies AG, Neubiberg (DE)

(72) Inventors: Muhammad FURQAN, Linz (AT); Faisal AHMED, Engerwitzdorf (AT); Jan Mateusz ZALESKI, Altenberg bei Linz (AT)

(21) Appl. No.: 18/886,114

(22) Filed: Sep. 16, 2024

(30) Foreign Application Priority Data
Sep. 22, 2023 (DE) 102023209296.4

(51) Int. Cl. G01S 7/40; G01S 7/03; G01S 7/35

(52) U.S. Cl. CPC G01S 7/40; G01S 7/03; G01S 7/352

(57) ABSTRACT

The present disclosure describes an integrated radar transceiver circuit. The integrated radar transceiver circuit includes a local oscillator, LO, circuit configured to provide an LO signal having a LO frequency, a test signal generator circuit configured to generate a test signal having a test signal frequency component, an up-conversion circuit configured to mix the test signal and the LO signal to obtain an up-converted test signal, a receive channel including a down-conversion circuit configured to mix the up-converted test signal and the LO signal to obtain a down-converted test signal, a phase detector circuit configured to determine a phase of the down-converted test signal and a processor configured to determine delay information related to the integrated radar transceiver circuit based on the determined phase.

### CROSS-REFERENCE TO RELATED APPLICATION

This application claims priority to Germany Patent Application No. 102023209296.4 filed on Sep. 22, 2023, the content of which is incorporated by reference herein in its entirety.

### TECHNICAL FIELD

The present disclosure relates to integrated radar transceiver circuits and methods for measuring delay information, such as group delay or phase transfer functions related to the integrated radar transceiver circuits.

### BACKGROUND

Group delay is a concept used in signal processing and communication systems to characterize the time delay experienced by different frequency components of a signal when passing through a system or a device. In simpler terms, it measures how much a system delays the propagation of different frequencies within a signal. When a signal with multiple frequencies passes through a system, each frequency component can experience a different delay, resulting in a phase shift for each frequency component. Group delay represents the rate of change of phase shift with respect to frequency. Mathematically, the group delay τ at a specific angular frequency ω=2πf is calculated as the negative derivative of the phase response φ of the system with respect to angular frequency:

$$τ ( ω ) = - d φ ( ω ) / d ω$$

where τ(ω) is the group delay at angular frequency ω, φ(ω) is the phase response at angular frequency ω, dφ(ω) is the derivative of the phase response with respect to angular frequency ω.

Group delay may be represented in units of time, such as seconds or milliseconds, and it is a function of frequency. It may provide information about the time dispersion introduced by a system, allowing to analyze and optimize the behavior of systems, especially in applications where precise timing is important.

Accurate and absolute phase and group delay measurement/monitoring of a receiver (Rx) subsystem is becoming a key requirement for cascading Frequency-Modulated Continuous-Wave (FMCW) Monolithic Microwave Integrated Circuits (MMICs). The Rx subsystem refers to a receiver section of the MMIC responsible for detecting and processing the radar echoes or return signals. Especially with increasing number of radar MMICs used for cascading which means different MMICs operating at different process, voltage, and temperature (PVT) corners, it is foreseen that each MMICs in the cascaded system would be required to be calibrated for reaching required inter-chip phase synchronization.

Furthermore, future radar systems will be operated at increasingly higher Intermediate Frequency (IF) bandwidths making the inter-chip phase synchronization even a bigger challenge. In a FMCW radar system, the IF bandwidth refers to the range of frequencies over which received radar signals are processed and analyzed. The IF bandwidth determines the system's ability to detect and accurately measure the frequency difference (beat frequency) between the transmitted and received signals, which is essential for calculating the range and velocity of the targets.

Current solutions to the problems include, for example, phase calibration by measurement of corner frequency for which errors start to increase with IF bandwidth.

Hence, there is a need for an improved concept for phase and group delay measurement/monitoring.

### SUMMARY

This need is addressed by apparatuses and methods in accordance with the appended claims.

According to a first aspect, the present disclosure proposes an integrated radar transceiver circuit (e.g., MMIC). The integrated radar transceiver circuit includes a local oscillator (LO) circuit configured to provide an LO signal having an LO frequency. The integrated radar transceiver circuit further includes a test signal generator circuit configured to generate at least one test signal having at least one test signal frequency component. While the LO frequency may be in the millimeter-wave frequency range (e.g., 76 to 81 GHz), the at least one test signal may have test signal frequency components in a much lower IF frequency range from 300 kHz to 30 MHz, for example. The at least one test signal may be a digital test signal which may be converted from digital to analog domain in the integrated radar transceiver circuit. The integrated radar transceiver circuit further includes an up-conversion circuit configured to mix the test signal and the LO signal to obtain an up-converted test signal (in the millimeter-wave frequency range).

The integrated radar transceiver circuit further includes at least one Rx channel (of an Rx subsystem). The Rx channel includes a down-conversion circuit configured to mix the up-converted test signal (in the millimeter-wave frequency range) and the LO signal to obtain a down-converted test signal (in the IF frequency range). The Rx channel further includes a phase detector circuit configured to determine at least one phase of the down-converted test signal. The integrated radar transceiver circuit further includes a processor which is configured to determine delay information related to the integrated radar transceiver circuit based on the at least one determined phase.

If a test signal with a plurality of test signal frequency components (e.g., a non-sinusoidal test signals) or a plurality of test signals with respective single test signal frequency components (e.g., sinusoidal test signals) are used, a plurality of phases and thus a baseband (BB) or IF group delay versus frequency of one or more Rx channels may be measured.

In some implementations, the test signal generator circuit is configured to generate at least one further second test signal after the phase of the down-converted test signal has been determined. The second test signal has a second test signal frequency component which is different (e.g., higher or lower) from the (first) test signal frequency component. The up-conversion circuit is configured to mix the second test signal and the LO signal to obtain a second up-converted test signal. The down-conversion circuit is configured to mix the second up-converted test signal and the LO signal to obtain a second down-converted test signal. The phase detector circuit is configured to determine a second phase of the second down-converted test signal. The processor is configured to determine a BB or IF group delay based on the determined (first) phase and the second phase. The group delay τ may be expressed as

$$τ = - \frac{∅ ( f 2 ) - ∅ ( f 1 )}{2 π ( f 2 - f 1 )}$$

where Ø(f) is phase in radians at test frequency component f.

In this way, phase errors caused by IF or BB processing of the integrated radar transceiver circuit may be measured and compensated by further processing.

The skilled person having benefit from the present disclosure will appreciate that more than two test signals (with different test signal frequencies) may be used to increase the granularity of the group delay information.

In some implementations, the test signal generator circuit is configured to generate the (first) test signal with the (first) test signal frequency component at a lower frequency end of an operation baseband (BB or IF) frequency range and to generate the second test signal with the second test signal frequency component at an upper frequency end of the operation baseband (BB or IF) frequency range, or vice versa. The operation baseband (BB or IF) frequency range of the integrated radar transceiver circuit may range from 300 kHz to 30 MHZ, for example.

In some implementations, the test signal generator circuit is configured to generate the (first) test signal as a (first) sinusoidal signal having the (first) test signal frequency component and to subsequently generate a second test signal as a second sinusoidal signal having a second test signal frequency component. Here, each sinusoidal test signal has a respective single test signal frequency.

In some implementations, the test signal generator circuit is configured to generate the test signal as a non-sinusoidal signal having a plurality of test signal frequency components. For example, the non-sinusoidal signal may include a rectangular signal pulse having multiple test signal frequency components within the operation baseband (BB or IF) frequency range. The phase detector circuit is configured to determine respective phases of the plurality of test signal frequency components of the down-converted test signal, and the processor is configured to determine a group delay related to the integrated radar transceiver circuit based on the respective phases of the plurality of test signal frequency components. For this purpose, the processor may be configured to perform a Fast Fourier transform (FFT) of the down-converted test signal.

In some implementations, the test signal generator circuit is configured to generate the at least one test signal as digital test signal. The integrated radar transceiver circuit further includes digital-to-analog conversion (DAC) circuitry configured to convert the at least one digital test signal from digital to analog signal domain. Thus, the resulting analog test signal may then be mixed with the analog LO signal to obtain the analog up-converted test signal (in the millimeter-wave frequency range).

In some implementations, the Rx channel includes analog-to-digital conversion (ADC) circuitry configured to convert the at least one down-converted test signal from analog to digital signal domain. Thus, the resulting down-converted test signal (in the IF frequency range) may then be processed by digital signal processing algorithms, such as an FFT, for example.

In some implementations, the test signal generator circuit is configured to generate the at least one test signal based on a digital clock signal having a clock spread of less than 200 ps over a range of +/−10% of a nominal supply voltage and a temperature range of −40° C. to 135° C. This clock spread may also be referred to as PVT clock spread due to PVT variations due to manufacturing processes, supply voltage levels, and operating temperatures that can lead to variability in the behavior of electronic components.

As mentioned before, the integrated radar transceiver circuit may include DAC circuitry configured to convert the at least one digital test signal from digital to analog signal domain. The RX channel may include ADC circuitry configured to convert the at least one down-converted test signal from analog to digital signal domain. The integrated radar transceiver circuit is configured to synchronize the test signal generator circuit, the DAC circuitry, and the ADC circuitry based on the digital clock signal. The low clock spread of the digital clock signal may yield highly synchronized sub-systems of the integrated radar transceiver circuit.

In some implementations, the integrated radar transceiver circuit further includes a compensation circuit configured to perform phase compensation in the Rx channel based on the determined delay information. For example, when determining a Range-Doppler map, the delay information (group delay) may be used to correct phases of Range-Doppler bins according to the respective delay information.

According to a further aspect, the present disclosure proposes a method for measuring (group) delay in an integrated radar transceiver circuit. The method includes generating at least one test signal having at least one test signal frequency component. The method includes mixing the test signal and an LO signal having an LO frequency to obtain an up-converted test signal. This may be done in a transmitter (Tx) portion of the integrated radar transceiver circuit. The method further includes mixing the up-converted test signal and the LO signal to obtain a down-converted test signal. This may be done in a receiver (Rx) portion of the integrated radar transceiver circuit. The method further includes determining a at least one phase of the down-converted test signal. This may be done by FFT processing, for example. The method further includes determining delay information related to the integrated radar transceiver circuit based on the at least one determined phase. The delay information may lead to group delay information if at least two sinusoidal test signals with different test signal frequencies are used or one non-sinusoidal test signal with multiple frequency components is used.

In some implementations, the method further includes generating a second test signal having a second test signal frequency component different from the test signal frequency component. The second test signal and the LO signal are mixed (in the Tx portion) to obtain a second up-converted test signal. The second up-converted test signal and the LO signal are mixed (in the Rx portion) to obtain a second down-converted test signal. A second phase of the second down-converted test signal is determined (for example, by FFT processing in the Rx portion). The (group) delay information may then be determined based on the first and the second phase, e.g., according to

$$τ = - \frac{∅ ( f 2 ) - ∅ ( f 1 )}{2 π ( f 2 - f 1 )} .$$

In some implementations, the (first) test signal is generated as a sinusoidal signal having the (first) test signal frequency component and the second test signal is generated as a sinusoidal signal having the second test signal frequency component. Also, the test signals may be generated as digital test signals, respectively.

In some implementations, the test signal is generated as a non-sinusoidal signal (e.g., rectangular pulses) having a plurality of test signal frequency components. Respective phases of the plurality of test signal frequency components of the down-converted test signal may be determined, e.g., by FFT processing. A group delay related to the integrated radar may be determined based on the respective phases of the plurality of test signal frequency components.

According to yet a further aspect, the present disclosure proposes an integrated radar transceiver circuit. The integrated radar transceiver circuit includes a test signal generator circuit configured to generate a test signal having a test signal frequency. The integrated radar transceiver circuit further includes an LO circuit configured to provide a first LO signal having a first LO frequency and an up-conversion circuit configured to mix the test signal and the first LO signal to obtain a first up-converted test signal. The integrated radar transceiver circuit includes at least one Rx channel which includes a down-conversion circuit configured to mix the first up-converted test signal and the first LO signal to obtain a first down-converted test signal. The Rx channel further includes a phase detector circuit configured to determine a first phase of the first down-converted test signal. After having processed the first LO signal, the LO circuit is configured to provide a second LO signal having a second LO frequency different from the first LO frequency. The up-conversion circuit is configured to mix the test signal and the second LO signal to obtain a second up-converted test signal. The down-conversion circuit is configured to mix the second up-converted test signal and the second LO signal to obtain a second down-converted test signal. The phase detector circuit is configured to determine a second phase of the second down-converted test signal. A processor configured to determine (group) delay information related to the integrated radar transceiver circuit based on the first and the second phase. The group delay τ may then be expressed as

$$τ = - \frac{∅ ( f 2 ) - ∅ ( f 1 )}{2 π ( f 2 - f 1 )}$$

where Ø(f) is the determined phase in radians for LO frequency fᵢ.

In this way, phase errors caused by LO processing of the integrated radar transceiver circuit may be measured and compensated.

In some implementations, the test signal generator circuit is configured to generate the test signal as a sinusoidal signal (having only a single frequency component).

In some implementations, the test signal generator circuit is configured to generate the test signal as a digital test signal. The integrated radar transceiver circuit further includes DAC circuitry configured to convert the test signal from digital to analog signal domain.

In some implementations, the up-conversion circuit and the down-conversion circuit are configured to perform the respective mixing in the analog signal domain.

In some implementations, the Rx channel includes ADC circuitry configured to convert the first and second down-converted test signals from analog to digital signal domain.

In some implementations, the test signal generator circuit is configured to generate the test signal based on a digital clock signal having a clock spread lower than 200 ps over a range of supply voltage of +/−10% of a nominal supply voltage and a range of temperature of −40° C. to 135° C.

In some implementations, the integrated radar transceiver circuit is configured to synchronize the test signal generator circuit, the digital-to-analog conversion circuitry, and the analog-to-digital conversion circuitry based on the digital clock signal.

In some implementations, the LO circuit is configured to generate the first LO signal with the first LO frequency at a lower frequency end of an FMCW frequency ramp and to generate the second LO signal with the second LO frequency at an upper frequency end of the FMCW frequency ramp, or vice versa. The FMCW frequency ramp may be in a frequency band between 76 GHz and 81 GHz, for example.

In some implementations, the integrated radar transceiver circuit further includes a compensation circuit configured to perform phase compensation in the Rx channel based on the determined delay information.

According to yet a further aspect, the present disclosure proposes a corresponding method for measuring group delay in an integrated radar transceiver circuit. The method includes generating a test signal having a test signal frequency, generating a first LO signal having a first LO frequency, mixing the test signal and the first LO signal to obtain a first up-converted test signal, mixing the first up-converted test signal and the first LO signal to obtain a first down-converted test signal, determining a first phase of the first down-converted test signal, generating a second LO signal having a second LO frequency different from the first LO frequency, mixing the test signal and the second LO signal to obtain a second up-converted test signal, mixing the second up-converted test signal and the second LO signal to obtain a second down-converted test signal, determining a second phase of the second down-converted test signal, and determining (group) delay information related to the integrated radar transceiver circuit based on the first and the second phase.

According to a further aspect, the present disclosure proposes a radar transceiver circuit integrated in a semiconductor chip, including a test signal generator circuit configured to generate at least one baseband test signal having at least one test signal frequency component.

The radar transceiver circuit further includes at least one receive channel including a node to receive the baseband test signal, the at least one receive channel configured to process the baseband test signal to generate a processed test signal. A phase detector circuit is provided and configured to determine a phase of the processed test signal and a processor (140) is configured to determine delay information related to the integrated radar transceiver circuit based on the determined phase.

The skilled person having benefit from the present disclosure will appreciate that the concepts of measuring and compensating the phase errors caused by baseband processing and measuring and compensating the phase errors caused by LO processing may be combined.

### BRIEF DESCRIPTION OF THE DRAWINGS

Some examples of apparatuses and/or methods will be described in the following by way of example only, and with reference to the accompanying figures, in which

FIG. 1 illustrates a block diagram of an integrated radar transceiver circuit (MMIC);

FIG. 2A illustrates an effective clock spread of 230 ps with 4 buffers after bifurcation point between ADC and test signal generator (TSG);

FIG. 2B illustrates effective clock spread of 150 ps with 2 buffers before bifurcation point between ADC and TSG and 2 buffers after;

FIG. 3A illustrates an effect of clock spread to phase estimation in the Rx subsystem for different IF frequencies;

FIG. 3B illustrates how phase estimation errors translate to errors in angle-of-arrival (AoA) measurements for different AoA;

FIG. 4 illustrates a flowchart of a method for measuring group delay in a radar MMIC according to a first implementation;

FIG. 5 illustrates a flowchart of a method for measuring group delay in a radar MMIC according to a second implementation; and

FIG. 6 illustrates a flowchart of a method for measuring group delay in a radar MMIC according to a third implementation.

### DETAILED DESCRIPTION

Some examples are now described in more detail with reference to the enclosed figures. However, other possible examples are not limited to the features of these implementations described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, e.g., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

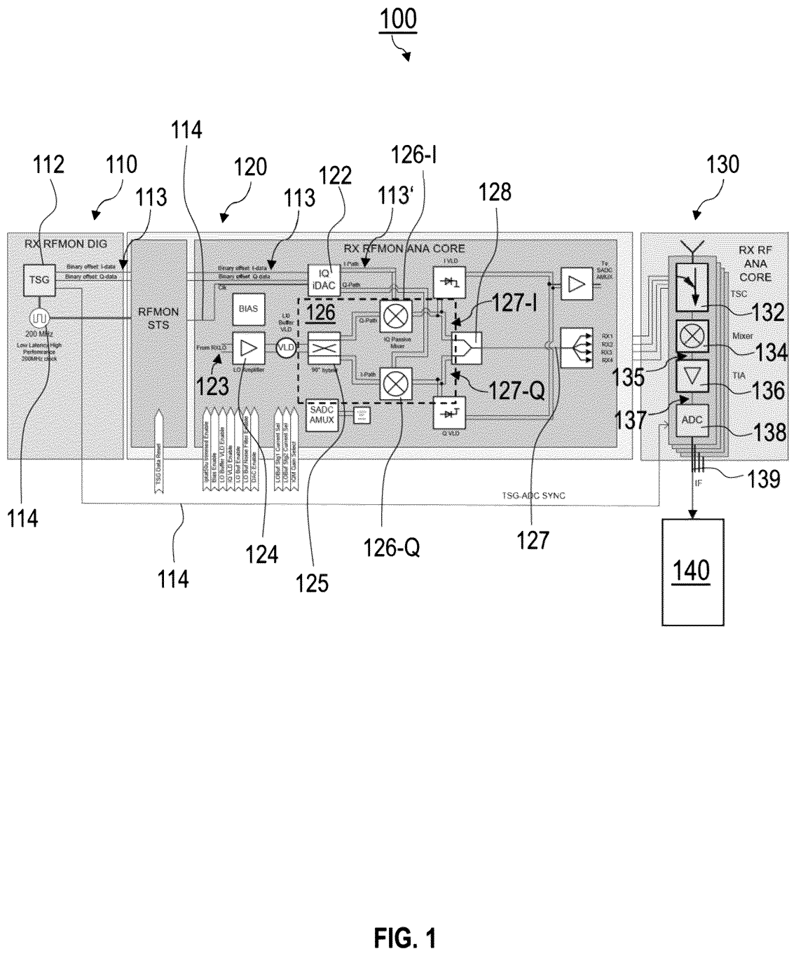

FIG. 1 shows a block diagram of an integrated radar transceiver circuit (MMIC) 100 for which different kinds of delay information related to the radar MMIC 100 shall be measured. The delay information may be used for compensating errors in phase estimation. When left uncompensated, such errors may lead to errors in angle measurements of a radar system.

Radar MMIC 100 may be a FMCW radar MMIC and comprises a digital subsystem 110, a transmitter (Tx) subsystem 120, and a receiver (Rx) subsystem 130 comprising one or more Rx channels of radar MMIC 100.

Digital subsystem 110 of radar MMIC 100 comprises a digital test signal generator circuit 112 which is configured to generate at least one digital test signal 113. The digital test signal 113 has at least one test signal frequency component f1. The at least one test signal frequency component f1 may be in the IF bandwidth of the radar MMIC 100, sometimes referred to as baseband of the radar MMIC 100. The IF bandwidth refers to the range of frequencies over which received radar signals are processed and analyzed. The IF bandwidth determines the MMIC's 100 ability to detect and accurately measure the frequency difference (beat frequency) between Tx and Rx signals, which is essential for calculating a range and velocity of targets. The IF bandwidth of radar MMIC 100 may range from 300 kHz to 30 MHZ, for example. Thus, the at least one test signal frequency component f1 of digital test signal 113 may be in that frequency range.

As will be explained in more detail in the sequel of this disclosure, digital test signal generator circuit 112 may, in some implementations, subsequently generate a plurality of sinusoidal test signals 113 at different test signal frequencies, for example during different time intervals. In other implementations, digital test signal generator circuit 112 may generate a single digital test signal 113 having a single or multiple frequency components. In the latter case, digital test signal generator circuit 112 may be configured to generate a digital test signal 113 with rectangular signal pulse shape, for example. In another implementation, digital test signal generator circuit 112 may be configured to generate a digital test signal 113 including a plurality of frequency components based on an inverse FFT (IFFT), for example. In the illustrated example, the digital test signal 113 is a digital IQ signal comprising an in-phase (I) data component and a quadrature (Q) data component.

The digital test signal generator circuit 112 is configured to generate the digital test signal(s) based on a clock signal 114 provided by some clock generation circuit (not shown) of MMIC 100. Clock signal 114 may determine a sample rate of digital test signal 113 as well as a sampling frequency of various DAC and ADC circuits of Tx subsystem 120 and Rx subsystem 130. In the illustrated example, clock signal 114 has a clock rate of 200 MHz. Clock signal 114 may be a highly stable clock signal and have a clock spread or clock variation of less than 200 ps over a range of supply voltage of +/−10% of a nominal supply voltage and a range of temperature of −40° C. to 135° C., for example. This means that edges of the clock signal 114 do not shift more than 200 ps in the supply voltage range of +/−10% of the nominal supply voltage and in the temperature range of −40° C. to 135° C. As will be described, low clock spreads can be achieved for example by reducing the number of buffers.

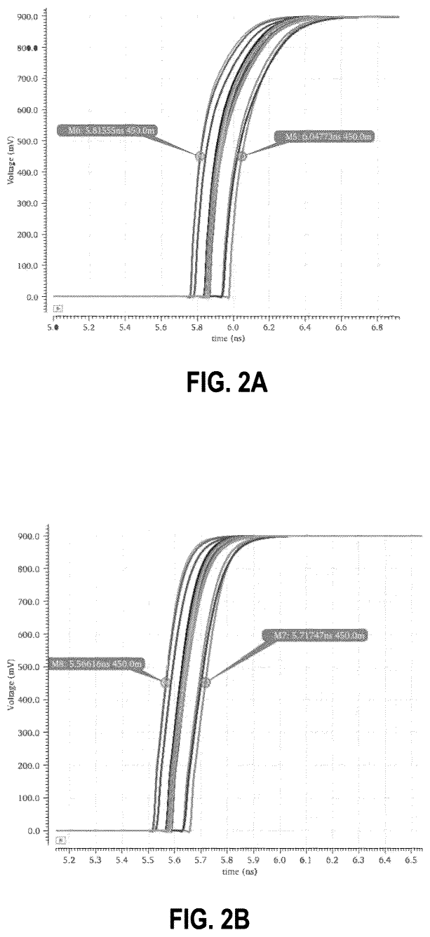

As illustrated in FIG. 1, clock signal 114 is commonly used as clock signal by digital subsystem 110, Tx subsystem 120, and Rx subsystem 130 for test signal generation, DAC processing (in Tx subsystem 120) and ADC processing (in Rx subsystem 130), thus providing synchronization between the different subsystems of radar MMIC 100. Using the same clock source for test signal generation and ADC processing may minimize the errors caused by spread of clock signal 114. A length of clock signal lines after a bifurcation point (not shown) between ADC processing and test signal generation is implemented to be as short as possible. Any buffers used before the bifurcation point do not contribute to phase errors. Buffers used after the bifurcation point between Rx ADC processing and digital test signal generation may contribute to phase errors depending on their position. FIG. 2A illustrates an effective clock spread (of clock signal 114) of 230 ps with four buffers after the bifurcation point between Rx ADC processing and digital test signal generation. FIG. 2B illustrates an effective clock spread (of clock signal 114) of only 150 ps with two buffers before and two buffers after the bifurcation point between Rx ADC processing and digital test signal generation. Accordingly, in some examples the number of buffers after the bifurcation point between Rx ADC processing and digital test signal generation are reduced, for example to 2 or less.

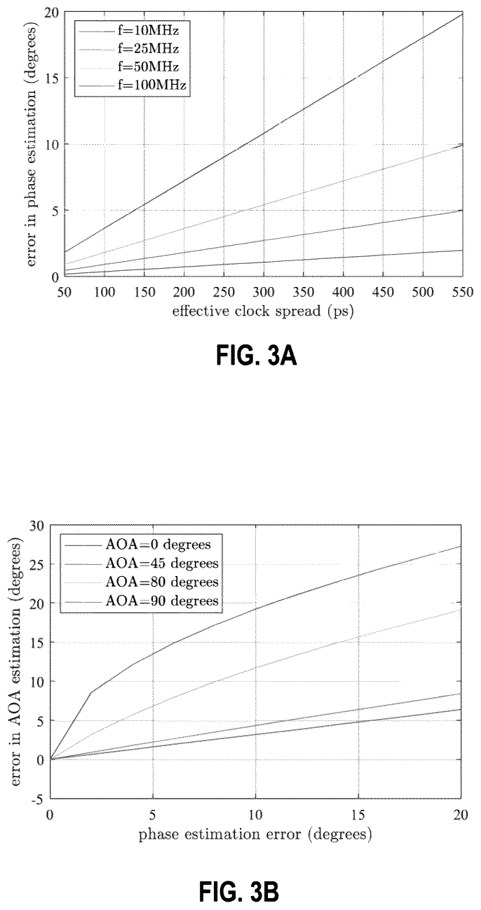

FIG. 3A illustrates the effect that clock spread has to phase estimation in the Rx subsystem 130 for different IF frequencies. It can be seen that a large clock spread may lead to remarkable errors in phase estimation. FIG. 3B illustrates how phase estimation errors translate to errors in angle-of-arrival (AoA) measurements for different AoA. The skilled person having benefit of the present disclosure will therefore appreciate that a low clock spread of clock signal 114 and/or knowledge of signal delays due to BB or IF processing as well as due to LO processing may be beneficial for reducing and compensating phase estimation errors.

The digital test signal 113 generated by digital test signal generator circuit 112 and the clock signal 114 are routed from digital subsystem 110 to Tx subsystem 120. There, the clock signal 114 is used to clock an IQ-DAC 122 which is configured to convert the I- and Q-components of the digital test signal 113 from digital to analog signal domain. The output of IQ-DAC 122 then provides I-and Q-components of an analog test signal 113′ corresponding to digital test signal 113.

In some examples, the digital test signal 113 or the analog test signal 113′ may be provided directly to a node of a baseband of one or more Rx channels of Rx subsystem 130. In some examples, as will be described in the following, the analog test signal 113′ is mixed with an LO signal and provided to an RF node of RX subsystem 130. To this end, Tx subsystem 120 comprises an LO amplifier 124 which is configured to amplify an analog LO signal 123. LO amplifier 124 is followed by an IQ up-conversion circuit 126 including a quadrature mixer. LO signal 123 may be generated using a Phase-Locked Loop (PLL) circuit internal or external to radar MMIC 100. LO signal 123 has an LO frequency in the millimeter-wave frequency range (e.g., 76 to 81 GHz) and thus a higher frequency than the at least one test signal frequency component of test signal 113, 113′.

IQ up-conversion circuit 126 downstream of LO amplifier 124 comprises a 90-degree phase shifter 125 to generate I-and Q-components of the analog LO signal 123 as well as two mixers 126-I, 126-Q, one for each of the I-and Q-components of analog test signal 113′, to generate quadrature components 127-I, 127-Q of an up-converted test signal 127 at the output of IQ up-conversion circuit 126 by mixing the quadrature components of the analog test signal 113′ with the respective quadrature components of LO signal 123. The quadrature components 127-I, 127-Q may be combined to up-converted test signal 127 by combiner 128.

Up-converted test signal 127 may then be coupled into one or more Rx channels via respective couplers 132 of Rx subsystem 130. Up-converted test signal 127 may then be treated as a receive signal of the respective Rx channel. In the example of FIG. 1, radar MMIC 100 comprises four Rx channels. The skilled person having benefit from the present disclosure will appreciate that the number of Rx channels of radar MMIC 100 may be lower or higher.

Each Rx channel of radar MMIC 100 comprises a down-conversion circuit or mixer 134 which is configured to mix the received up-converted test signal 127 and the LO signal 123 to obtain an analog down-converted test signal 135 in the IF band of the radar MMIC 100. Analog down-converted test signal 135 may optionally be amplified by amplifier 136 (e.g., a Low-Noise Amplifier, LNA) and then be converted from analog to digital signal domain using ADC circuitry 138. It is to be noted that for a direct insertion of the analog test signal 113′ in the baseband of RX subsystem 130 as mentioned before, the processing of the inserted analog test signal 113′ corresponds to the processing of the down-converted test signal 135 as described below. ADC circuitry 138 of each Rx channel is clocked by clock signal 114, thus providing synchronization between digital subsystem 110, Tx subsystem 120, and Rx subsystem 130. In the ideal case of no frequency or phase errors, the resulting digital down-converted test signal 139 in the Rx channel will correspond to the reference digital test signal 113. However, due to signal processing delays in the Rx channel, the digital down-converted test signal 139 is likely to be phase shifted with respect to the reference digital test signal 113, resulting in non-zero phases (with respect to the digital test signal 113) of the digital down-converted test signal 139 for the one or more test signal frequency components.

FIG. 1 also shows a processor 140 downstream of ADC 138. Processor 140 may be internal (built-in) or external to radar MMIC 100. Processor 140 may comprise digital signal processing circuitry configured to determine at least one phase of digital down-converted test signal 139. Thus, processor 140 may comprise a phase detector. For example, the at least one phase of digital down-converted test signal 139 may be determined by performing an FFT of the digital down-converted test signal 139. The phase of a bin in the FFT represents the complex angle of the sinusoidal component that contributes to that specific frequency bin. In other words, the phase of the bin indicates the starting angle of the sinusoid at that particular frequency. The phase information is crucial for reconstructing the original time-domain signal from the frequency-domain representation provided by the FFT. To determine the phase of a bin, one may compute the arctangent (or inverse tangent) of the imaginary part divided by the real part of the complex number corresponding to that bin. This may be expressed as follows: Phase(bin)=tan⁻¹(Imaginary(bin), Real(bin)). Further, processor 140 is configured to determine (group) delay information related to the integrated radar transceiver circuit 100 based on the determined phase(s).

For this, the present disclosure proposes either at least two (sinusoidal) digital test signals 113 with respective different test signal frequencies or a (non-sinusoidal) test signal with at least two test signal frequency components.

In the first alternative, the (internal or external) LO circuit is configured to generate the LO signal 123 with a fixed LO frequency f_{LO}. The test signal generator circuit 112 is configured to generate a first digital sinusoidal test signal 113 having a first test signal frequency f₁ in the IF band. The up-conversion circuit 126 is configured to mix the first test signal 113, 113′ and the LO signal 123 to obtain a first up-converted test signal 127. The down-conversion circuit 134 of the Rx channel is configured to mix the first up-converted test signal 127 and the LO signal 123 to obtain a first down-converted test signal 135, 139. The phase detector circuit or processor 140 is configured to determine a first phase ϕ(f₁) of the first down-converted test signal corresponding to the first test signal frequency f₁. While the LO frequency f_{LO} of LO signal 123 remains unchanged, the test signal generator circuit 112 is configured to subsequently generate a second sinusoidal test signal 113 having a second test signal frequency f₂ different from the first test signal frequency f₁. The different test signal frequencies f₁ and f₂ may be generated according to a time-multiplexing scheme, for example. While the first test signal frequency f₁ may be at a lower end of IF frequency range, the second test signal frequency f₂ may be at an upper end of the IF frequency range, or vice versa. In this way, most of the IF frequency range of radar MMIC 100 may be covered. The up-conversion circuit 126 is configured to mix the second test signal 113 (having the second test signal frequency f₂) and the LO signal 123 to obtain a second up-converted test signal 127. The down-conversion circuit 134 of the Rx channel is configured to mix the second up-converted test signal 127 and the LO signal 123 to obtain a second down-converted test signal 135, 139. The phase detector circuit or processor 140 is configured to determine a second phase φ(f₂) of the second down-converted test signal 135, 139 corresponding to the second test signal frequency f₂. With this delay information, the processor 140 may be configured to determine a group delay τ related to the radar MMIC 100 based on the determined first phase ϕ(f₁) and the second phase ϕ(f₂) corresponding to

$$τ = - \frac{∅ ( f 2 ) - ∅ ( f 1 )}{2 π ( f 2 - f 1 )} .$$

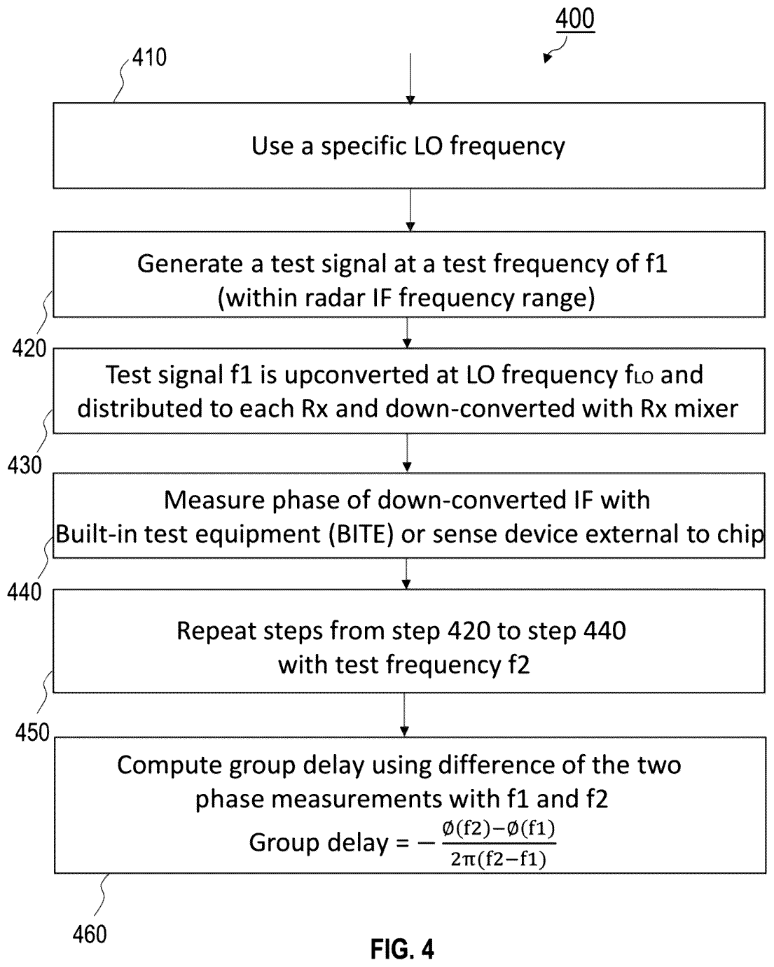

This first alternative of determining the BB group delay is summarized by method 400 for measuring the group delay in radar MMIC 100. A flowchart of method 400 is illustrated in FIG. 4. In other examples the above described first and second test signals 113, 113′ having a first test signal frequency f₁ and a second test signal frequency f₂ may be directly inserted in the baseband as mentioned above with a processing corresponding to the processing of the down-converted signals 135, 139.

Method 400 includes an act 410 of providing the LO signal 123 with a fixed LO frequency f_{LO}. Method 400 includes an act 420 of generating a first test signal 113, 113′ having a first test signal frequency f₁. Method 400 includes an act 430 of mixing the first test signal 113′ and the LO signal 123 to obtain a first up-converted test signal 127 and mixing the first up-converted test signal 127 and the LO signal 123 to obtain a first down-converted test signal 135, 139. Method 400 includes an act 440 of measuring a first phase ϕ(f₁) of the first down-converted test signal 139. The acts 410 to 440 to may then be repeated for at least one further second test signal 113, 113′ having a second test signal frequency f₂. Then, method 400 includes an act 460 of determining the group delay τ related to the radar MMIC 100 based on the determined first phase ϕ(f₁) and the second phase ϕ(f₂) in accordance with the above formula.

In the second alternative, the test signal generator circuit 112 is configured to generate a non-sinusoidal test signal 113, 113′ having both a first test signal frequency component f₁ and at least a second test signal frequency component f₂ in the IF band. The skilled person having benefit from the present disclosure will appreciate that more than two test signal frequency components are possible. While the first test signal frequency component f₁ may be at a lower end of the IF frequency range, the second test signal frequency component f₂ may be at an upper end of the IF frequency range, or vice versa. The (internal or external) LO circuit is configured to provide the LO signal 123 with a fixed LO frequency f_{LO}. The up-conversion circuit 126 is configured to mix the non-sinusoidal test signal 113′and the LO signal 123 to obtain an up-converted test signal 127. The down-conversion circuit 134 of the Rx channel is configured to mix the up-converted test signal 127 and the LO signal 123 to obtain a down-converted test signal 135, 139 comprising the first and second test signal frequency components f₁, f₂. The processor 140 is configured to determine a first phase ϕ(f₁) of the down-converted test signal corresponding to the first test signal frequency component f₁ and to determine a second phase ϕ(f₂) of the down-converted test signal corresponding to the second test signal frequency component f₂. This may be done via an FFT, for example. With this phase information, the processor 140 may be configured to determine the group delay τ related to the radar MMIC 100 based on the determined first phase ϕ(f₁) and the second phase ϕ(f₂) in accordance with the above formula.

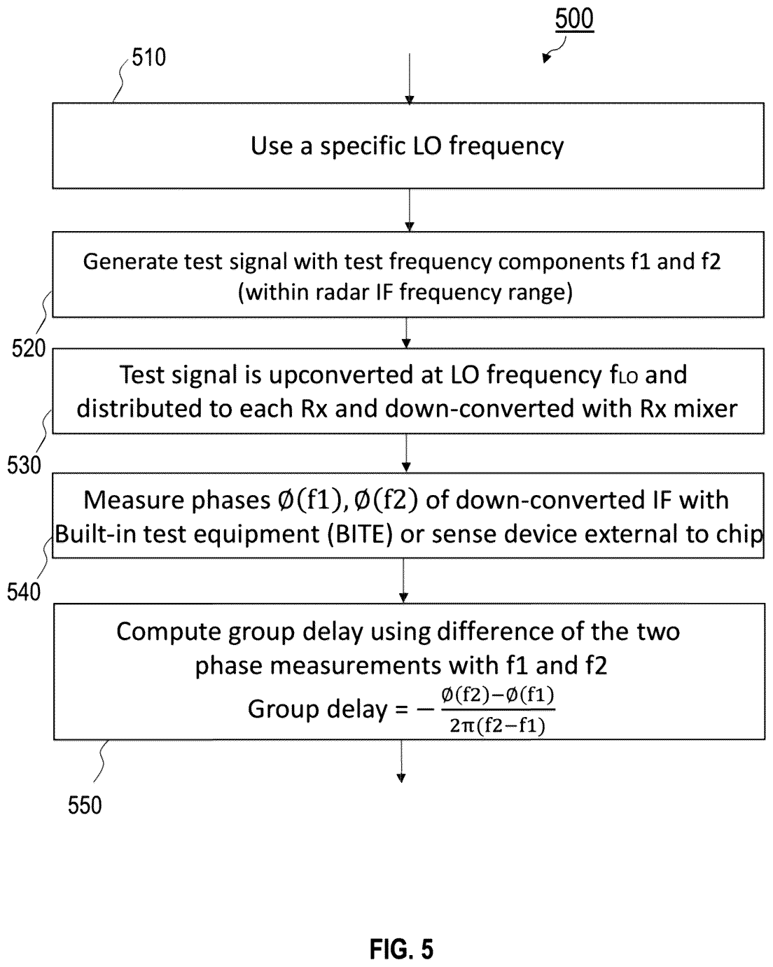

This second alternative of determining the BB group delay is summarized by method 500 for measuring the group delay in radar MMIC 100. A flowchart of method 500 is illustrated in FIG. 5.

Method 500 includes an act 510 of providing the LO signal 123 with a fixed LO frequency f_{LO}. Method 500 includes an act 520 of generating the test signal 113, 113′ having a first test signal frequency component f₁ and at least a second test signal frequency component f₂. Method 500 includes an act 530 of mixing the test signal 113′ and the LO signal 123 to obtain an up-converted test signal 127 and mixing the up-converted test signal 127 and the LO signal 123 to obtain a down-converted test signal 135, 139. Method 400 includes an act 540 of measuring a first phase ϕ(f₁) corresponding to the first test signal frequency component f₁ and a second phase ϕ(f₂) corresponding to the second test signal frequency component f₂ of the down-converted test signal 139. Then, method 500 includes an act 550 of determining the group delay τ related to the radar MMIC 100 based on the determined first phase ϕ(f₁) and the second phase ϕ(f₂) in accordance with the above formula.

Again, the above described methods may be used in a similar manner for baseband test signals which are inserted directly in the baseband processing of the Rx channel.

The present disclosure further provides for measuring an LO transfer function.

Here, the test signal generator circuit 112 is configured to generate a sinusoidal test signal having 113, 113′ having a test signal frequency fₜₑₛₜ. The LO circuit is configured to generate a first LO signal 123 having a first LO frequency f_{LO1}. Up-conversion circuit 126 is configured to mix the test signal 113′ and the first LO signal 123 to obtain a first up-converted test signal 127. Down-conversion circuit is configured to mix the first up-converted test signal 127 and the first LO signal 123 to obtain a first down-converted test signal 135, 139. The phase detector circuit or processor 140 is configured to determine a first phase ϕ(f_{LO1}) of the first down-converted test signal resulting from the first LO signal. While the test signal frequency of test signal having 113, 113′remains unchanged, the LO circuit is configured to subsequently generate a second LO signal 123 having a second LO frequency f_{LO2} different from the first LO frequency f_{LO1}. The different LO frequencies f_{LO1} and f_{LO2} may be generated according to a time-multiplexing scheme, for example. While the first LO frequency f_{LO1} may be at a lower end of an FMCW frequency ramp, the second LO frequency f_{LO2} may be at an upper end of the FMCW frequency ramp, or vice versa. In this way, most of the RF frequency range of radar MMIC 100 may be covered. The up-conversion circuit 126 is configured to mix the sinusoidal test signal 113 (having the fixed test signal frequency fₜₑₛₜ) and the second LO signal 123 to obtain a second up-converted test signal 127. The down-conversion circuit 134 of the Rx channel is configured to mix the second up-converted test signal 127 and the second LO signal 123 to obtain a second down-converted test signal 135, 139. The phase detector circuit or processor 140 is configured to determine a second phase ϕ(f_{LO2}) of the second down-converted test signal 135, 139 resulting from the second LO signal. With this delay information, the processor 140 may be configured to determine an LO transfer function τ related to the radar MMIC 100 based on the determined first phase ϕ(f_{LO1}) and the second phase ϕ(f_{LO2}) corresponding to

$$τ = - \frac{∅ ( fLO 2 ) - ∅ ( fLO 1 )}{2 π ( fLO 2 - fLO 1 )} .$$

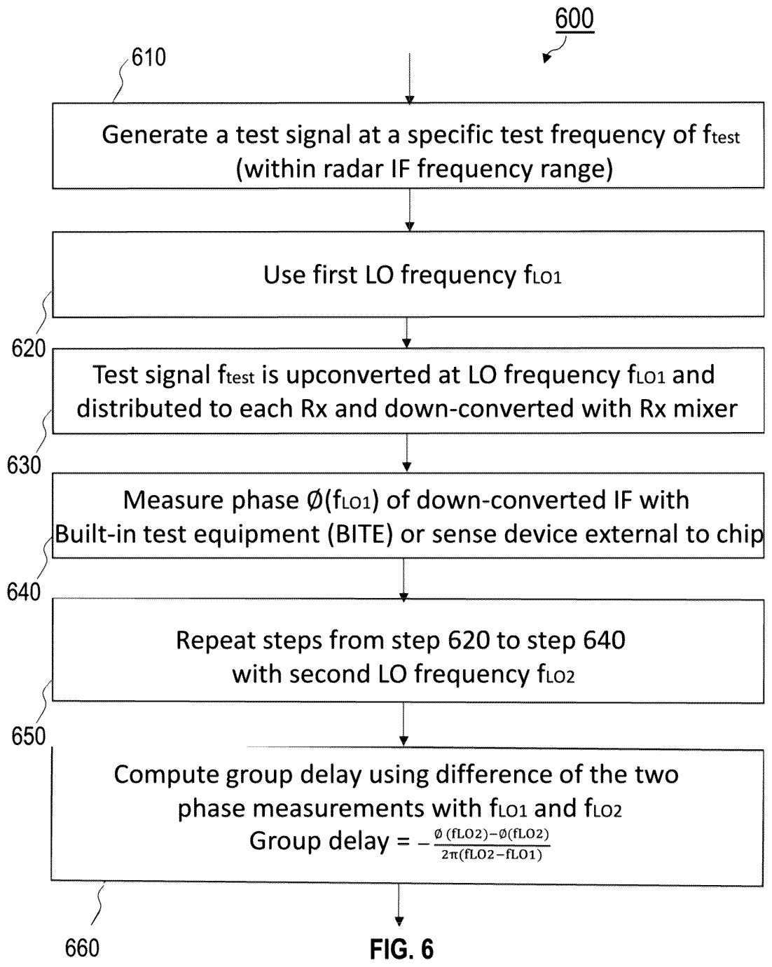

This alternative of determining the LO transfer function is summarized by method 600 for measuring the LO transfer function in radar MMIC 100. A flowchart of method 600 is illustrated in FIG. 6.

Method 600 includes an act 610 of providing the test signal 113, 113′ with a fixed test signal frequency fₜₑₛₜ. Method 600 includes an act 620 of generating a first LO signal 123 having a first LO frequency f_{LO1}. Method 600 includes an act 630 of mixing the test signal 113′ and the first LO signal 123 to obtain a first up-converted test signal 127 and mixing the first up-converted test signal 127 and the first LO signal 123 to obtain a first down-converted test signal 135, 139. Method 600 includes an act 440 of measuring a first phase ϕ(f_{LO1}) of the first down-converted test signal 139. The acts 610 to 640 to may then be repeated for at least one further second LO signal 123 having a second LO frequency f_{LO2}. Then, method 600 includes an act 660 of determining the LO transfer function/group delay τ related to the radar MMIC 100 based on the determined first phase ϕ(f_{LO1}) and the second phase ϕ(f_{LO2}) in accordance with the above formula.

Baseband phase can be computed from group delay by assuming 0° phase at a reference frequency. The difference in phase compared to a reference channel is the phase error caused by baseband. The LO phase can be computed by

$$∅ = \frac{2 π * τ * c 0}{λ}$$

where τ is group delay. The difference in phase compared to a reference channel is the phase error caused by LO. The phase error cause by baseband and LO can be adjusted in the phase response of each channel before performing an angle FFT.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An integrated radar transceiver circuit, comprising:
a local oscillator (LO) circuit configured to provide an LO signal having a LO frequency;
a test signal generator circuit configured to generate at least one test signal having at least one test signal frequency component;
an up-conversion circuit configured to mix the at least one test signal and the LO signal to obtain an up-converted test signal;
at least one receive channel, comprising a down-conversion circuit configured to mix the up-converted test signal and the LO signal to obtain a down-converted test signal;
a phase detector circuit configured to determine a phase of the down-converted test signal; and
a processor configured to determine delay information related to the integrated radar transceiver circuit based on the phase of the down-converted test signal.

2. The integrated radar transceiver circuit of claim 1, wherein:
the test signal generator circuit is configured to generate a second test signal having a second test signal frequency component different from the at least one test signal frequency component;
the up-conversion circuit is configured to mix the second test signal and the LO signal to obtain a second up-converted test signal;
the down-conversion circuit is configured to mix the second up-converted test signal and the LO signal to obtain a second down-converted test signal;
the phase detector circuit is configured to determine a second phase of the second down-converted test signal; and
the processor is configured to determine a group delay related to the integrated radar transceiver circuit based on the phase of the down-converted test signal and the second phase of the second down-converted test signal.

3. The integrated radar transceiver circuit of claim 2, wherein the test signal generator circuit is configured to:
generate the at least one test signal with the at least one test signal frequency component at a lower frequency end of an operation baseband frequency range and to generate the second test signal with the second test signal frequency component at an upper frequency end of the operation baseband frequency range, or
generate the at least one test signal with the at least one test signal frequency component at the upper frequency end of the operation baseband frequency range and to generate the second test signal with the second test signal frequency component at the lower frequency end of the operation baseband frequency range.

4. The integrated radar transceiver circuit of claim 1, wherein the test signal generator circuit is configured to generate the at least one test signal as a sinusoidal signal having the at least one test signal frequency component and to subsequently generate a second test signal as a sinusoidal signal having a second test signal frequency component.

5. The integrated radar transceiver circuit of claim 1, wherein:
the test signal generator circuit is configured to generate the at least one test signal as a non-sinusoidal signal having a plurality of test signal frequency components;
the phase detector circuit is configured to determine respective phases of the plurality of test signal frequency components of the down-converted test signal; and
the processor is configured to determine a group delay related to the integrated radar based on the respective phases of the plurality of test signal frequency components.

6. The integrated radar transceiver circuit of claim 1, wherein:
the LO circuit is configured to provide a second LO signal having a second LO frequency different from the LO frequency;
the up-conversion circuit is configured to mix the at least one test signal and the second LO signal to obtain a second up-converted test signal;
the down-conversion circuit is configured to mix the second up-converted test signal and the second LO signal to obtain a second down-converted test signal;
the phase detector circuit is configured to determine a second phase of the second down-converted test signal; and
the processor is configured to determine the delay information based on the phase of the down-converted test signal and the second phase of the second down-converted test signal.

7. The integrated radar transceiver circuit of claim 6, wherein the LO circuit is configured to provide the LO signal with the LO frequency at a lower frequency end of a FMCW frequency ramp and the second LO signal with the second LO frequency at an upper frequency end of the FMCW frequency ramp.

8. The integrated radar transceiver circuit of claim 1,
wherein the test signal generator circuit is configured to generate the at least one test signal as at least one digital test signal, and
wherein the integrated radar transceiver circuit further comprises digital-to-analog conversion circuitry configured to convert the at least one digital test signal from digital to analog signal domain.

9. The integrated radar transceiver circuit of claim 8, wherein the test signal generator circuit is configured to generate the at least one digital test signal based on a clock signal having a clock spread lower than 200 ps over a range of supply voltage of +/−10% of a nominal supply voltage and a range of temperature of −40 to 135 degree C.

10. The integrated radar transceiver circuit of claim 9, wherein the at least one receive channel comprises analog-to-digital conversion circuitry configured to convert the down-converted test signal from analog to digital signal domain, and
wherein the integrated radar transceiver circuit is configured to synchronize the test signal generator circuit, the digital-to-analog conversion circuitry, and the analog-to-digital conversion circuitry based on the clock signal.

11. The integrated radar transceiver circuit of claim 1, further comprising:
a compensation circuit configured to perform phase compensation in the at least one receive channel based on the determined delay information.

12. A method for measuring group delay in an integrated radar transceiver circuit, the method comprising:
generating at least one test signal having at least one test signal frequency component;
mixing the at least one test signal and an LO signal having an LO frequency to obtain an up-converted test signal;
mixing the up-converted test signal and the LO signal to obtain a down-converted test signal;
determining a phase of the down-converted test signal; and
determining delay information related to the integrated radar transceiver circuit based on the phase of the down-converted test signal.

13. The method of claim 12, further comprising:
generating a second test signal having a second test signal frequency component different from the at least one test signal frequency component;
mixing the second test signal and the LO signal to obtain a second up-converted test signal;
mixing the second up-converted test signal and the LO signal to obtain a second down-converted test signal;
determining a second phase of the second down-converted test signal; and
determining the delay information based on the phase of the down-converted test signal and the second phase.

14. The method of claim 13, wherein the at least one test signal is generated as a sinusoidal signal having the at least one test signal frequency component and the second test signal is generated as a sinusoidal signal having the second test signal frequency component.

15. The method of claim 12, comprising:
generating the at least one test signal as a non-sinusoidal signal having a plurality of test signal frequency components;
determining respective phases of the plurality of test signal frequency components of the down-converted test signal; and
determining a group delay related to the integrated radar transceiver circuit based on the respective phases of the plurality of test signal frequency components.

16. The method of claim 15, wherein the respective phases of the plurality of test signal frequency components are determined based on a Fast Fourier Transform of the down-converted test signal.

17. The method of claim 12, comprising:
providing a second LO signal having a second LO frequency different from the LO frequency;
mixing the at least one test signal and the second LO signal to obtain a second up-converted test signal;
mixing the second up-converted test signal and the second LO signal to obtain a second down-converted test signal;
determining a second phase of the second down-converted test signal; and
determining the delay information based on the phase of the down-converted test signal and the second phase.

18. The method of claim 17, wherein the LO signal is provided with the LO frequency at a lower frequency end of a FMCW frequency ramp and the second LO signal is provided with the second LO frequency at an upper frequency end of the FMCW frequency ramp, or
wherein the LO signal is provided with the LO frequency at the upper frequency end of the FMCW frequency ramp and the second LO signal is provided with the second LO frequency at the lower frequency end of the FMCW frequency ramp.

19. A radar transceiver circuit integrated in a semiconductor chip, comprising:
a test signal generator circuit configured to generate at least one baseband test signal having at least one test signal frequency component;
at least one receive channel comprising a node to receive the at least one baseband test signal, the at least one receive channel configured to process the at least one baseband test signal to generate a processed test signal;
a phase detector circuit configured to determine a phase of the processed test signal; and
a processor configured to determine delay information related to the integrated radar transceiver circuit based on the determined phase.

20. The radar transceiver circuit of claim 19, wherein the test signal generator circuit is configured to generate a first baseband test signal having a first frequency and a second baseband test signal having a second frequency.
